(19) United States
(12) Patent Application Publication
(10) Pub. No.: US 2025/0182049 A1
(43) Pub. Date: Jun. 5, 2025

(54) REFRIGERATOR AND METHOD FOR CONTROLLING SAME

(71) Applicant: SAMSUNG ELECTRONICS CO., LTD., Suwon-si (KR)

(72) Inventor: Hyunji LEE, Suwon-si (KR)

(73) Assignee: SAMSUNG ELECTRONICS CO., LTD., Suwon-si (KR)

(21) Appl. No.: 19/052,861

(22) Filed: Feb. 13, 2025

Related U.S. Application Data
(63) Continuation of application No. PCT/KR2023/014190, filed on Sep. 19, 2023.

(30) Foreign Application Priority Data
Oct. 20, 2022 (KR) 10-2022-0135944

(51) Int. Cl. G06Q 10/087; F25D 29/00; G06V 20/52; G06V 20/68

(52) U.S. Cl. CPC G06Q 10/087; F25D 29/005; G06V 20/52; G06V 20/68; F25D 2400/36

(57) ABSTRACT

A refrigerator comprising: a plurality of storage rooms; a camera; a memory; and at least one processor configured to: recognize a type of food material to be added to the refrigerator based on an image captured by the camera; obtain ethylene information related to the food material on the basis of a type of food material; obtain information related to at least one other food material stored in the plurality of storage rooms; identify a storage room in which the food material is to be stored, among the plurality of storage rooms, on the basis of the ethylene information related to the food material and the information related to the at least one food material; and provide the identified information on the storage room.

### CROSS-REFERENCE TO RELATED APPLICATION

This application is a continuation application is a continuation application, under 35 U.S.C. § 111(a), of international application No. PCT/KR2023/014190, filed Sep. 19, 2023, which claims priority under 35 U. S. C. § 119 to Korean Patent Application No. 10-2022-0135944, filed Oct. 20, 2022, the disclosures of which are incorporated herein by reference in their entireties.

### TECHNICAL FIELD

Embodiments below relate to a refrigerator and a method for controlling the same. Specifically, types of food material to be added in the refrigerator may be recognized with a camera disposed at a front surface thereof, and information on a storage compartment in which food materials are to be stored may be provided taking into consideration the recognized types of food materials from among a plurality of storage compartments of the refrigerator.

### BACKGROUND ART

Through a refrigeration cycle that uses a refrigerant, refrigerators may be refrigerators (or, home appliances) which can store foods (or, food products, food) that can be drunk or eaten in a refrigerated storage or a frozen storage. The refrigerator may not only store foods, but also medicines, alcoholic liquors, or cosmetics.

Through technological advances, refrigerators may not only provide storage, but also various services through transmitting and receiving data or through installable (or, downloadable) applications.

### DISCLOSURE

### Technical Solution

According to an embodiment of the disclosure, a refrigerator includes a plurality of storage compartments, a camera, a memory, and at least one processor. The processor is configured to recognize a type of food material to be added in the refrigerator based on an image obtained through the camera, obtain ethylene information associated with the food material based on the type of the food material, obtain information associated with at least one other food material stored in the plurality of storage compartments, identify, based on the ethylene information associated with the food material and the information associated with the at least one other food material, a storage compartment in which the food material is to be stored either separately or collectively with the at least one other food material from among the plurality of storage compartments, and provide information about the identified storage compartment.

According to an embodiment of the disclosure, a method for controlling a refrigerator including a plurality of storage compartments, and a camera where the method includes recognizing a type of food material to be added in the refrigerator based on an image obtained through the camera, obtaining ethylene information associated with the food material based on the type of food material, obtaining information associated with at least one other food material stored in the plurality of storage compartments, identifying, based on the ethylene information associated with the food material and the information associated with the at least one other food material, a storage compartment in which the food material are to be stored from among the plurality of storage compartments, and providing information about the identified storage compartment.

According to an embodiment of the disclosure, a computer-readable recording medium that stores programs for executing a control method of a refrigerator, the control method including recognizing a type of food material to be added in the refrigerator based on a image obtained through a camera, obtaining ethylene information associated with the food material based on the type of food material, obtaining information associated with at least one other food material stored in the plurality of storage compartments, identifying, based on the ethylene information associated with the food material and the information associated with the at least one food material, a storage compartment in which the food material is to be stored from among the plurality of storage compartments, and providing information about the identified storage compartment.

### DESCRIPTION OF DRAWINGS

FIG. 1 is a block diagram illustrating a configuration of a refrigerator according to an embodiment of the disclosure;

FIG. 2 is a flowchart illustrating a method of providing information about a storage compartment of a refrigerator according to an embodiment of the disclosure;

FIG. 3 is a table for describing ethylene information according to an embodiment of the disclosure;

FIG. 4 is a table for describing information about a storage compartment in which food materials are to be stored according to an embodiment of the disclosure;

FIG. 5 is a block diagram illustrating a detailed configuration of a refrigerator according to an embodiment of the disclosure;

FIG. 6 is a flowchart illustrating a control method of a refrigerator according to an embodiment of the disclosure; and

FIG. 7 is a sequence diagram illustrating a control method of a refrigerator according to an embodiment of the disclosure.

### MODE FOR INVENTION

Various modifications may be made to the embodiments of the disclosure, and there may be various types of embodiments. Accordingly, specific embodiments will be illustrated in drawings, and described in detail in the detailed description. However, it should be noted that the various embodiments are not for limiting the scope of the disclosure to a specific embodiment, and should be interpreted to include all modifications, equivalents or alternatives of the embodiments included in the ideas and the technical scopes disclosed herein. With respect to the description of the drawings, like reference numerals may be used to indicate like elements.

In describing the disclosure, in case it is determined that the detailed description of related known technologies or configurations may unnecessarily confuse the gist of the disclosure, the detailed description thereof will be omitted.

Further, the embodiments below may be modified to various different forms, and it is to be understood that the scope of the technical spirit of the disclosure is not limited to the embodiments below. Rather, the embodiments are provided so that the disclosure will be thorough and complete, and to fully convey the technical spirit of the disclosure to those skilled in the art.

Terms used in the disclosure have been merely used to describe a specific embodiment, and is not intended to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) at least one A, (2) at least one B, or (3) both of at least one A and at least one B.

Expressions such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

Conversely, when a certain element (e.g., first element) is indicated as “directly coupled with/to” or “directly connected to” another element (e.g., second element), it may be understood as the other element (e.g., third element) not being present between the certain element and the another element.

The expression “configured to . . . (or set up to)” used in the disclosure may be used interchangeably with, for example, “suitable for . . . ”, “having the capacity to . . . ”, “designed to . . . ”, “adapted to . . . ”, “made to . . . ”, or “capable of . . . ” based on circumstance. The term “configured to . . . (or set up to)” may not necessarily mean “specifically designed to” in terms of hardware.

Rather, in a certain circumstance, the expression “a device configured to . . . ” may mean something that the device “may perform . . . ” together with another device or components. For example, a phrase “a processor configured to (or set up to) perform A, B, or C” may mean a dedicated processor for performing a relevant operation (e.g., an embedded processor), or a generic-purpose processor (e.g., a central processing unit (CPU) or an application processor) capable of performing the relevant operations by executing one or more software programs stored in a memory device.

The term “module” or “part” used in embodiments herein perform at least one function or operation, and may be implemented with a hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

Meanwhile, the various elements and areas of the drawings have been schematically illustrated. Accordingly, the technical spirit of the disclosure is not limited by relative sizes and distances illustrated in the accompanied drawings.

Embodiments of the disclosure will be described in detail with reference to the accompanying drawings below to aid in the understanding of a person of ordinary skill in the art.

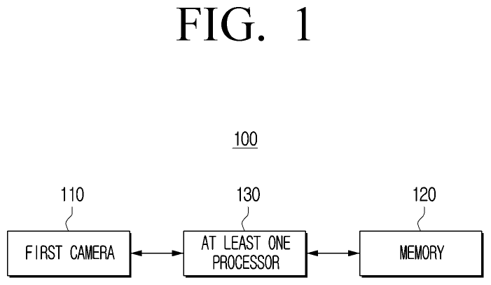

FIG. 1 is a block diagram illustrating a configuration of a refrigerator according to an embodiment of the disclosure.

Referring to FIG. 1, a refrigerator 100 may include a first camera 110, a memory 120, and at least one processor 130.

The first camera 110 according to an embodiment may be a configuration for capturing a subject and generating a captured image, and here, the captured image may be a concept that includes both a moving image and a still image. The first camera 110 may obtain an image of at least one external device, and may be implemented with a first camera, a lens, an infrared sensor, and the like.

The first camera 110 may include a lens and an image sensor. Types of lenses may include a typical generic-purpose lens, a wide angle lens, a zoom lens, and the like, and may be determined according to a type, characteristic, use environment, and the like of the refrigerator 100. For the image sensor, a complementary metal oxide semiconductor (CMOS), a charge coupled device (CCD), and the like may be used.

The first camera 110 may output light incident as an image signal. Specifically, the first camera 110 may include a lens, pixels, and an AD converter. The lens may gather light of a subject forming an optical image at a capturing area, and the pixels may output light incident through the lens as an image signal in analog form. Further, the AD converter may convert and output the image signal in analog form to an image signal in digital form. Specifically, the first camera 110 may be disposed so as to capture a front direction of the refrigerator 100, and generate a captured image by capturing a user present at a front surface of the refrigerator.

Specifically, the first camera 110 may be attached to a front surface of the refrigerator 100, and may capture food materials to be stored in the refrigerator 100. As described above, new food materials being stored in the refrigerator 100 may be recognized based on an image obtained by the first camera 110. In addition, types of the food materials may be recognized based on the image obtained by the first camera 110. Further, a second camera may be included in addition to the first camera 110. At this time, the second camera may capture an image by being attached to a different position from the first camera 110, and information associated with other food materials may be obtained based on an image obtained through the second camera.

The memory 120 according to an embodiment may store necessary data for an embodiment of the disclosure. The memory 120 may be implemented in a form of a memory embedded in the refrigerator 100 according to data storage use, or implemented in a form attachable to or detachable from the refrigerator 100.

For example, data for the driving of the refrigerator 100 may be stored in the memory embedded in the refrigerator 100, and data for an expansion function of the refrigerator 100 may be stored in the memory attachable to or detachable from the refrigerator 100. Meanwhile, the memory embedded in the refrigerator 100 may be implemented as at least one of a volatile memory (e.g., a dynamic RAM (DRAM), a static RAM (SRAM), or a synchronous dynamic RAM (SDRAM)), or a non-volatile memory (e.g., an one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)). In the case of the memory attachable to or detachable from the refrigerator 100, the memory may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., USB memory) connectable to a USB port, or the like. According to an example, the memory 120 may store at least one instruction for controlling the refrigerator 100 or a computer program including instructions.

Specifically, the memory 120 may store types of food materials stored in the refrigerator 100 and images. Further, the memory 120 may store types of other food materials stored in the refrigerator 100 and images. In addition, the memory 120 may store ethylene information associated with the food materials. Further, the memory 120 may store an artificial intelligence model trained to recognize the food materials.

The at least one processor 130 according to an embodiment of the disclosure may control an overall operation of the refrigerator 100.

According to an embodiment of the disclosure, the at least one processor 130 may be implemented as a digital signal processor (DSP) that processes a digital signal, a microprocessor, or a time controller (TCON). However, the embodiment is not limited thereto, and may include, for example, and without limitation, one or more from among a central processing unit (CPU), a micro controller unit (MCU), a micro processing unit (MPU), a controller, an application processor (AP), a communication processor (CP), an ARM processor, or an artificial intelligence (AI) processor, or may be defined by the relevant term. In addition, the at least one processor 130 may be implemented with a System on Chip (SoC) or a large scale integration (LSI) in which a processing algorithm is embedded, and may be implemented in a form of a field programmable gate array (FPGA). The at least one processor 130 may perform various functions by executing computer executable instructions stored in the memory.

The at least one processor 130 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 130 may control one or a random combination from among other elements of the electronic apparatus, and perform an operation associated with communication or data processing. The at least one processor 130 may execute one or more programs or instructions stored in the memory. For example, the at least one processor 130 may perform, by executing the one or more instructions stored in the memory, a method according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The at least one processor 130 may be implemented as a single core processor that includes one core, or implemented as one or more multicore processors that include a plurality of cores (e.g., a homogeneous multicore or a heterogeneous multicore). If the at least one processor 130 is implemented as a multicore processor, each of the plurality of cores included in the multicore processor may include a memory inside the processor such as a cache memory and an on-chip memory, and a common cache shared by the plurality of cores may be included in the multicore processor. In addition, each of the plurality of cores (or a portion from among the plurality of cores) included in the multicore processor may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processor. For example, when a first operation, a second operation, and a third operation are performed by a method according to an embodiment, the first operation, the second operation, and the third operation may all be performed by a first core included in the multicore processor, or the first operation and the second operation may be performed by the first core included in the multicore processor and the third operation may be performed by a second core included in the multicore processor.

Specifically, the at least one processor 130 may recognize types of food materials to be added in the refrigerator based on a first image obtained through the first camera.

Further, the at least one processor 130 may obtain ethylene information associated with the food materials based on the types of the food materials.

Further, the at least one processor 130 may obtain information associated with other food materials stored in a plurality of storage compartments.

Then, the at least one processor 130 may identify, based on the ethylene information associated with the food materials and the information associated with the other food materials, information about a storage compartment in which the food materials are to be stored from among the plurality of storage compartments.

Then, the at least one processor 130 may provide information about the identified storage compartment.

Here, the ethylene information may include a degree of incidence of ethylene in the food materials and a degree of sensitivity of the food materials to ethylene.

Then, the at least one processor 130 may further include a second camera disposed to face a storage compartment, and the at least one processor 130 may determine, based on a second image obtained through the second camera, a storage compartment in which the other food materials are stored.

Then, the at least one processor 130 may recognize types of the other food materials, and obtain, based on the recognized types of the other food materials, ethylene information associated with the other food materials.

Further, the at least one processor 130 may obtain, based on the storage compartment in which the other food materials are stored and the ethylene information associated with the other food materials, information associated with the other food materials.

Here, the ethylene information associated with the other food materials may include a degree of incidence of ethylene in the other food materials and a degree of sensitivity of the other food materials to ethylene.

Meanwhile, the at least one processor 130 may identify, based on the ethylene information associated with the food materials, the storage compartment in which the other food materials are stored, and the ethylene information associated with the other food materials, information about a storage compartment in which the other food materials are to be stored.

That is, the at least one processor 130 may identify, based on the degree of sensitivity of the food materials to ethylene and the degree of incidence of ethylene in the other food materials, information about a storage compartment in which the food materials are to be stored.

Alternatively, the at least one processor 130 may identify, based on the degree of incidence of ethylene in the food materials and the degree of sensitivity of the other food materials to ethylene, information about a storage compartment in which the food materials are to be stored.

Then, the at least one processor 130 may identify information about a storage compartment in which the food materials are to be stored based on temperatures of the plurality of storage compartments and a setting temperature of the refrigerator.

In addition, a display may be further included, and the at least one processor 130 may provide the information about the identified storage compartment to the display.

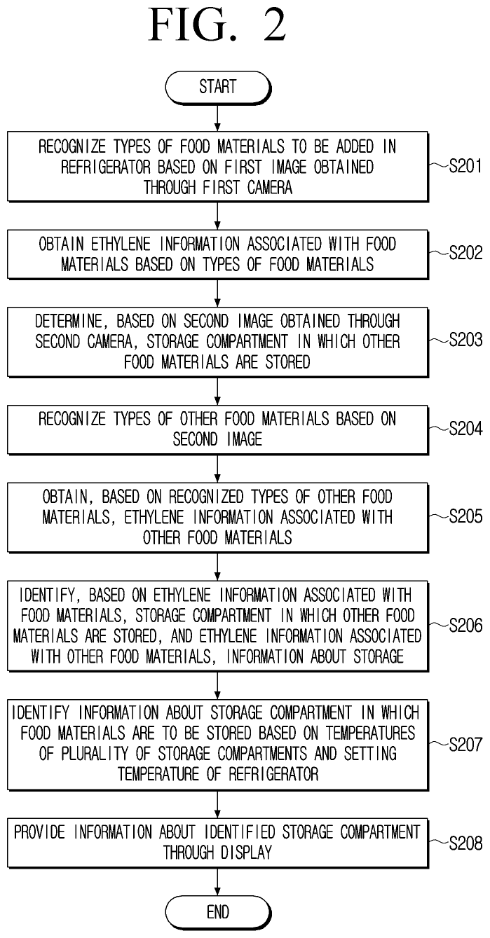

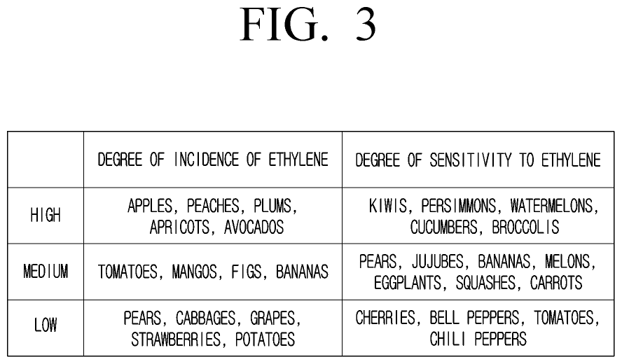

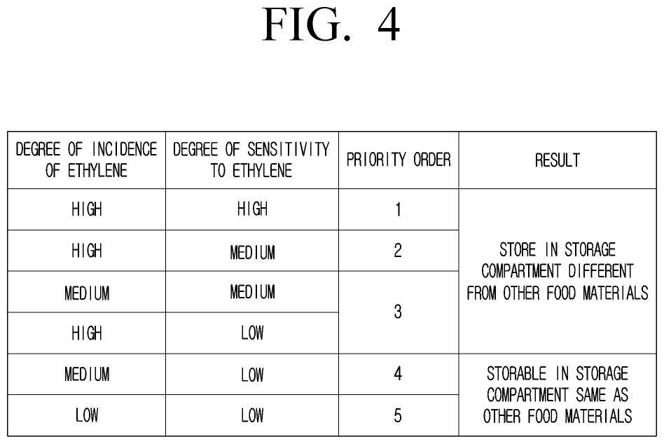

FIG. 2 is a flowchart illustrating a method for providing information about a storage compartment of a refrigerator according to an embodiment of the disclosure. In order to describe a method of providing information about a storage compartment of the refrigerator, the above will be described below with reference to FIG. 3 and FIG. 4.

Referring to FIG. 2, the at least one processor 130 may recognize the types of the food materials to be added in the refrigerator based on the first image obtained through the first camera (S201).

At this time, the at least one processor 130 may first recognize the types of the food materials by recognizing objects included in the first image. That is, the at least one processor 130 may recognize the types of the food materials included in the first image through a computer vision or an artificial intelligence model.

Then, the at least one processor 130 may determine whether the types are food materials to be added in the refrigerator taking into consideration a movement direction of the food materials recognized from the first image. That is, if the food materials are recognized as having been moved to an inside of a storage compartment of the refrigerator, the at least one processor 130 may recognize the food materials moved inside the storage compartment as food materials to be added in the refrigerator.

Further, the at least one processor 130 may obtain the ethylene information associated with the food materials based on the types of the food materials (S202). Here, the ethylene information may include the degree of incidence of ethylene in the food materials and the degree of sensitivity of the food materials to ethylene.

The degree of incidence of ethylene associated with food materials may correspond to a degree in which ethylene is generated according to the types of food materials, and the degree of sensitivity to ethylene may correspond to the extent to which food material are affected by ethylene according to the types of food material.

Here, ethylene may be a type of gas which can be generated from food materials, particularly from fruits and vegetables, and there may be a difference in incidence of ethylene associated with food materials according to the food material.

In addition, ethylene may affect a ripening state of fruits or vegetables. That is, ethylene may be a chemical material which can accelerate ripening of food materials, and if fruits or vegetables are stored in an environment in which ethylene is present, the ripening of the stored fruits or vegetables may be progressed. Here, the effect ethylene causes to the ripening state may vary according to the types of stored fruits or vegetables. That is, there may be a difference in the degree of sensitivity to ethylene associated with relevant food materials according to the food material.

FIG. 3 is a table for describing ethylene information according to an embodiment of the disclosure.

Referring to FIG. 3, the degree of incidence of ethylene according to the types of food materials and the degree of sensitivity to ethylene may be divided by high, medium, and low. Food materials with a high degree of incidence of ethylene may include apples, peaches, plums, apricots, and avocados. Further, food materials with a medium degree of incidence of ethylene may include tomatoes, mangos, figs, and bananas. In addition, food materials with a low degree of incidence of ethylene may include pears, cabbages, grapes, strawberries, and potatoes.

Further, food materials with a high degree of sensitivity to ethylene may include kiwis, persimmons, watermelons, cucumbers, broccolis. Further, food materials with a medium degree of sensitivity to ethylene may include pears, jujubes, bananas, melons, eggplants, squashes, and carrots. In addition, food materials with a low degree of sensitivity to ethylene may include cherries, bell peppers, tomatoes, and chili peppers.

Meanwhile, the above-described food materials according to the degree of incidence of ethylene and the degree of sensitivity to ethylene are merely examples, and other food materials in addition to the food materials in FIG. 3 may be added.

That is, the at least one processor 130 may obtain the degree of incidence of ethylene and the degree of sensitivity to ethylene of relevant food materials by identifying the types of the food materials according to a pre-defined standard as shown in FIG. 3.

Then, the at least one processor 130 may obtain information associated with other food materials stored in the plurality of storage compartments (S203). At this time, the obtaining information associated with other food materials may be for identifying information about a storage compartment in which the food materials are to be stored by also taking into consideration the ethylene information associated with the food materials.

That is, the at least one processor 130 may obtain the second image through the second camera disposed to face a storage compartment, and determine a storage compartment in which other food materials are stored based on the second image (S203). Here, the second camera may be disposed to capture the whole of the plurality of storage compartments included in the refrigerator 100, and the second image including the whole of the plurality of storage compartments may be obtained. Further, the second image may include other food materials included in the plurality of storage compartments. Here, the other food materials included in the second image may be one or more. That is, if the other food materials included in the second image is one or more, the at least one processor 130 may determine one or more storage compartments included with one or more other food materials based on the second image.

Then, the at least one processor 130 may recognize the types of the other food materials based on the second image (S204). That is, the at least one processor 130 may determine the types of the other food materials included in the second image through an object recognition algorithm. Here, the object recognition algorithm may be a computer vision or an artificial intelligence algorithm. If the other food materials included in the second image is one or more, types of the one or more other food materials may be respectively determined. In addition, if the types of the one or more other food materials are determined, the at least one processor 130 may generate a food material list, and store the types of the one or more other food materials and the stored storage compartment in the food material list.

Further, the at least one processor 130 may obtain, based on the recognized types of the other food materials, the ethylene information associated with the other food materials (S205).

Here, the ethylene information associated with the other food materials may include the degree of incidence of ethylene in the other food materials and the degree of sensitivity of the other food materials to ethylene.

That is, the at least one processor 130 may obtain the degree of incidence of ethylene and the degree of sensitivity to ethylene in the other food materials by identifying the types of the other food materials according to the pre-defined standard as shown in FIG. 3.

As described above, the at least one processor 130 may obtain, based on the storage compartment in which the other food materials are stored and the ethylene information associated with the other food materials, information associated with the other food materials. That is, in the information associated with the other food materials, the storage compartment stored with the other food materials and the ethylene information associated with the other food materials may be included.

Then, the at least one processor 130 may identify, based on the ethylene information associated with the food materials and the information associated with the other food materials, information about a storage compartment in which food materials are to be stored from among the plurality of storage compartments (S206). Accordingly, the at least one processor 130 may identify, the ethylene information associated with the food materials, the storage compartment in which the other food materials are stored, and the ethylene information associated with the other food materials, information about a storage compartment in which the food materials are to be stored.

For example, if the storage compartment in which the other food materials are stored is a first storage compartment from among the plurality of storage compartments in the refrigerator 100, and the first storage compartment is a storage compartment in which the food materials are to be stored, information about a storage compartment in which the food materials are to be stored may be identified based on the ethylene information associated with the food materials and the ethylene information associated with the other food materials stored in the first storage compartment. That is, taking into consideration both the ethylene information associated with the food materials and the ethylene information associated with the other food materials, information about a storage compartment in which the food materials are to be stored may be identified by determining whether the storage compartment in which the food materials are to be stored is the first storage compartment. Here, starting from the first storage compartment to the last storage compartment, the storage compartment for the food material is designated sequentially, and the information regarding the final storage room for the food material can be identified.

That is, the at least one processor 130 may identify, based on the degree of sensitivity of the food materials to ethylene and the degree of incidence of ethylene in the other food materials, information about a storage compartment in which the food materials are to be stored.

Alternatively, the at least one processor 130 may identify, based on and the degree of incidence of ethylene in the food materials and the degree of sensitivity of the other food materials to ethylene, information about a storage compartment in which the food materials are to be stored. A method of identifying information about a storage compartment in which food materials are to be stored will be described below with reference to FIG. 4.

FIG. 4 is a table for describing information about a storage compartment in which food materials are to be stored according to an embodiment of the disclosure.

Referring to FIG. 4, the at least one processor 130 may identify whether the food materials can be stored in the same storage compartment as the other food materials with the information on the storage compartment according to the degree of incidence of ethylene and the degree of sensitivity to ethylene.

Specifically, if the degree of the incidence of ethylene in the food materials is high, and the degree of sensitivity of the other food materials to ethylene is high, the at least one processor 130 may identify the having to store in a different storage compartment from the other food materials as the information about the storage compartment.

Further, if the degree of the incidence of ethylene in the food materials is high, and the degree of sensitivity of the other food materials to ethylene is medium, the at least one processor 130 may identify the having to store in a different storage compartment from the other food materials as the information about the storage compartment.

Further, if the degree of the incidence of ethylene in the food materials is medium, and the degree of sensitivity of the other food materials to ethylene is medium, the at least one processor 130 may identify the having to store in a different storage compartment from the other food materials as the information about the storage compartment.

Further, if the degree of the incidence of ethylene in the food materials is low, and the degree of sensitivity of the other food materials to ethylene is low, the at least one processor 130 may identify the having to store in a different storage compartment from the other food materials as the information about the storage compartment.

Meanwhile, if the degree of the incidence of ethylene in the food materials is medium, and the degree of sensitivity of the other food materials to ethylene is low, the at least one processor 130 may identify the being able to store in a same storage compartment as the other food materials as the information about the storage compartment.

In addition, if the degree of the incidence of ethylene in the food materials is low, and the degree of sensitivity of the other food materials to ethylene is low, the at least one processor 130 may identify the being able to store in a same storage compartment as the other food materials as the information about the storage compartment.

For example, if the food materials to be stored in the refrigerator 100 are apples, the at least one processor 130 may obtain the degree of incidence of ethylene in the food materials as high. Assuming that the storage compartment in which the apples are to be stored is the first storage compartment, the at least one processor 130 may obtain ethylene information associated with watermelons which are the other food materials stored in the first storage compartment. That is, the at least one processor 130 may obtain a degree of sensitivity of watermelons to ethylene as high. In this case, the at least one processor 130 may determine that the apples which are the food materials to be stored has to be stored in a different storage compartment from the watermelons.

Further, assuming that the storage compartment in which the apples are to be stored is a second storage compartment of the refrigerator 100, information associated with the other food materials stored in the second storage compartment may be obtained. Here, if the other food materials stored in the second storage compartment are tomatoes, the at least one processor 130 may obtain a degree of sensitivity of tomatoes to ethylene as low. In this case, the at least one processor 130 may determine the apple, which is the food material to be stored, as being storable in the second storage compartment.

In another example, if the food materials to be stored in the refrigerator 100 are tomatoes, the at least one processor 130 may obtain the degree of sensitivity of the tomatoes to ethylene as low. Assuming that the storage compartment in which the tomatoes are to be stored is the first storage compartment, the at least one processor 130 may obtain ethylene information associated with avocados which are the other food materials stored in the first storage compartment. That is, the at least one processor 130 may obtain a degree of incidence of ethylene in avocadoes as high. In this case, the at least one processor 130 may determine that the tomatoes which are the food materials to be stored have to be stored in a different storage compartment from the avocadoes.

Further, assuming that the storage compartment in which a kiwi is to be stored is the second storage compartment of the refrigerator 100, information associated with the other food materials stored in the second storage compartment may be obtained. Here, if the other food materials stored in the second storage compartment are strawberries, the at least one processor 130 may obtain a degree of incidence of ethylene in strawberries as low. In this case, the at least one processor 130 may determine that the tomatoes which are the food materials to be stored as being storable in the second storage compartment.

Further, the at least one processor 130 may determine a priority with the information about the storage compartment. That is, the at least one processor 130 may determine the priority based on ethylene information associated with the food materials to be stored and ethylene information associated with the other food materials stored in the refrigerator 100. The at least one processor 130 may identify information about a storage compartment in which the food materials are to be stored according to the determined priority.

For example, if the food materials to be stored in the refrigerator 100 are apples, the at least one processor 130 may obtain the degree of incidence of ethylene in tomatoes as high. Assuming that the storage compartment in which the tomatoes are to be stored is the first storage compartment, the at least one processor 130 may obtain ethylene information associated with cucumbers which are the other food materials stored in the first storage compartment. That is, the at least one processor 130 may obtain a degree of sensitivity of cucumbers to ethylene as high. In this case, the at least one processor 130 may identify a priority for having to store the apples which are food materials to be stored in a different storage compartment from the cucumbers as first.

Then, assuming that the storage compartment in which the apples are to be stored is the second storage compartment in the refrigerator 100, information associated with the other food materials stored in the second storage compartment may be obtained. Here, if the other food materials stored in the second storage compartment are melons, the at least one processor 130 may obtain a degree of incidence of ethylene in melons as medium. In this case, the at least one processor 130 may identify a priority for having to store the apples which are the food materials to be stored in a different storage compartment from the strawberries as second.

At this time, if the priority of all storage compartments other than the second storage compartment is first, the at least one processor 130 may identify the information about the storage compartment in which the apples are to be stored as the second storage compartment.

As described above, if the food materials to be stored are determined as to be stored in a different storage compartment from all of the storage compartments, the at least one processor 130 may identify the storage compartment with the lowest priority with the information about the storage compartment in which the food materials are to be stored.

As described above, if the food materials to be stored are determined as to be stored in a different storage compartment from all of the storage compartments, the at least one processor 130 may provide a storing method. For example, the at least one processor 130 may provide that the food materials to be stored may be covered in a plastic wrap and stored, or provide that the above may be stored contained in a separate container.

Then, the at least one processor 130 may identify information about a storage compartment in which the food materials are to be stored based on the temperatures of the plurality of storage compartments and the setting temperature of the refrigerator (S207). That is, the at least one processor 130 may compare the temperatures of the plurality of storage compartments with the setting temperature of the refrigerator 100, and identify a storage compartment that is different from the setting temperature by less than or equal to a pre-set temperature difference with information about the storage compartment in which the food materials are to be stored.

For example, if the food materials stored in the refrigerator 100 are apples, the at least one processor 130 may determine that the apples have to be stored in a different storage compartment from the watermelons by obtaining the degree of sensitivity of the watermelons stored in the first storage compartment to ethylene as high according to the degree of incidence of ethylene in apples which are determined as high.

Further, assuming that the storage compartment in which the apples are to be stored is the second storage compartment in the refrigerator 100, a temperature of the second storage compartment may be obtained. If a difference in the temperature of the second storage compartment and the setting temperature of the refrigerator 100 is determined as less than or equal to the pre-set temperature difference, the at least one processor 130 may obtain information associated with the other food materials stored in the second storage compartment. Here, if the other food materials stored in the second storage compartment are tomatoes, the at least one processor 130 may obtain the degree of sensitivity of the tomatoes to ethylene as low. In this case, the at least one processor 130 may determine that the apples which are the food materials to be stored are storable in the second storage compartment.

Then, the at least one processor 130 may provide the information about the identified storage compartment. Specifically, the display may be further included in the refrigerator 100, and the at least one processor 130 may provide the information on the identified storage compartment to the display. That is, the at least one processor 130 may display a number of a storage compartment in which the food materials have to be stored in the refrigerator 100 in the display.

Alternatively, the at least one processor 130 may provide a degree for the identified storage compartment through an audio outputter. That is, the at least one processor 130 may transfer a number of a storage compartment in which food materials are to be stored in the refrigerator 100 to the user through the audio outputter.

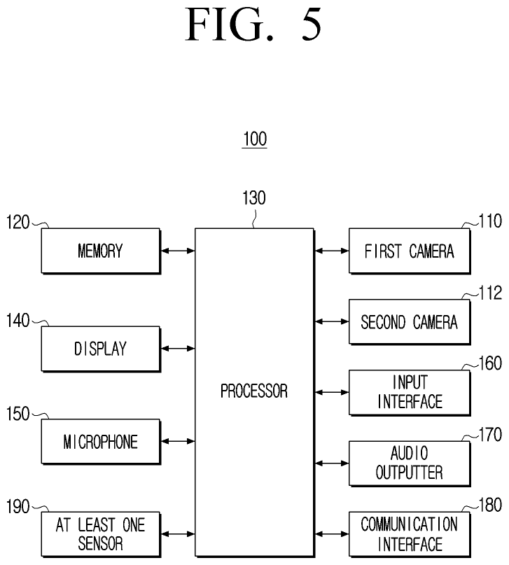

FIG. 5 is a block diagram illustrating a detailed configuration of a refrigerator according to an embodiment of the disclosure.

Referring to FIG. 5, the refrigerator 100 may include the first camera 110, a second camera 112, the memory 120, at least one processor 130, a display 140, a microphone 150, an input interface 160, an audio outputter 170, a communication interface 180, and at least one sensor 190. Detailed descriptions of configurations that overlap with the description in FIG. 1 will be omitted.

The display may include displays of various types such as, for example, and without limitation, a liquid crystal display (LCD) panel, an organic light emitting diode (OLED) panel, an active-matrix organic light-emitting diodes (AM-OLED), a liquid crystal on silicon (LcoS), a quantum dot light-emitting diode (QLED), a digital light processing (DLP), a Plasma Display Panel (PDP), inorganic LED panel, micro LED panel and the like, but is not limited thereto. Meanwhile, the display 140 may configure a touch screen together with a touch panel, and may be formed with a flexible panel. Specifically, the display 140 may provide the information about the identified storage compartment. For example, if the second storage compartment among the plurality of storage compartments is identified as the storage compartment for the food material, the display 140 may provide that the food materials to be stored is to be stored in the second storage compartment.

The microphone 150 may refer to a module that obtains sound and converts to an electric signal, and may be a condenser microphone, a ribbon microphone, a moving-coil microphone, a piezoelectric device microphone, a carbon microphone, or a micro electro mechanical system (MEMS) microphone. In addition, the above may be implemented in an omnidirectional method, a bidirectional method, a unidirectional method, a sub cardioid method, a super cardioid method, or a hyper cardioid method. Specifically, the microphone 150 may receive information associated with the food materials. For example, the microphone 150 may receive a type of food material by a voice input of the user, recognize the food material type based on the received voice input, and obtain the ethylene information associated with the relevant food material.

The input interface 160 may include circuitry, and receive input of a user command for setting or selecting various functions supported by the refrigerator 100. To this end, the input interface 160 may include a plurality of buttons, and may be implemented into a touch screen capable of simultaneously performing functions of the display.

In this case, the at least one processor 130 may control an operation of the refrigerator 100 based on a user command input through the input interface 160. For example, the at least one processor 130 may control the refrigerator 100 based on an on/off command of the refrigerator 100 input through the input interface 160, an on/off command of a function of the refrigerator 100, and the like. Specifically, the input interface 160 may receive information about a text image which is to be displayed with a substitute text image from the user.

The audio outputter 170 may output audio. Specifically, the at least one processor 130 may output various notification sounds or voice guidance messages associated with an operation of the refrigerator 100 through the audio outputter 170. Specifically, if the audio outputter 170 is formed of a configuration that can output only notification sounds such as a buzzer, the at least one processor 130 may output a notification sound notifying that the food materials have been obtained, and transmit the ethylene information associated with the obtained food materials or the information about the storage compartment in which the identified food materials are to be stored to an external electronic device. The information transmitted as described above may be verified through a mobile application from the external electronic device.

Meanwhile, if the audio outputter 170 is formed of a speaker that can output voice, the at least one processor 130 may output the ethylene information associated with the obtained food materials or the information about the storage compartment in which the identified food materials are to be stored through the speaker.

The communication interface 180 may include a wireless communication interface, a wired communication interface, or an input interface. The wireless communication interface may perform communication with various external devices using wireless communication technology or mobile communication technology. Examples of the mobile communication technology may include Bluetooth, Bluetooth Low Energy, CAN communication, Wi-Fi, Wi-Fi Direct, ultrawide band (UWB) communication, ZigBee, infrared data association (IrDA) communication, Near Field Communication (NFC), or the like, and examples of the mobile communication technology may include 3GPP, Wi-Max, Long Term Evolution (LTE), 5G, and the like. The wireless communication interface may be implemented using an antenna, a communication chip, substrates, and the like which can transmit electromagnetic waves to the outside or receive electromagnetic waves transferred from the outside. Specifically, the first image obtained through the communication interface 180 may be transmitted to a server, or the information about the identified storage compartment may be received from the server.

The at least one sensor 190 may sense an operating state (e.g., power or temperature) of the refrigerator 100, or an external environment state (e.g., user state), and generate an electric signal or a data value corresponding to the sensed state. Specifically, the at least one processor 130 may measure the respective temperatures of the plurality of storage compartments of the refrigerator 100 through sensing values obtained through the at least one sensor 190. Alternatively, the at least one processor 130 may recognize that the user is approaching through the at least one sensor 190, and control for the first camera 110 to be in a ready state.

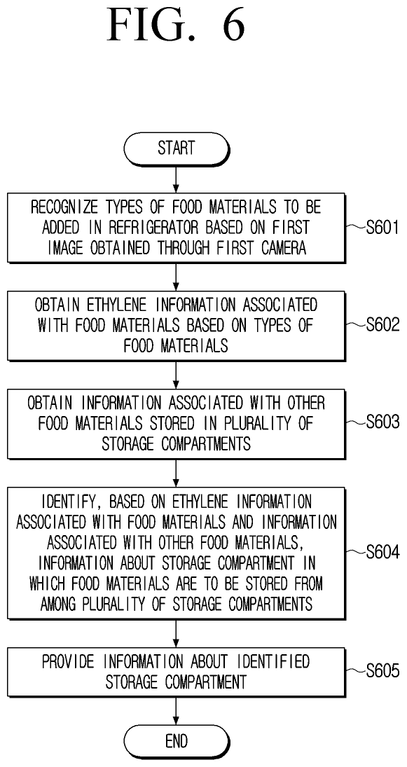

FIG. 6 is a flowchart illustrating a control method of a refrigerator according to an embodiment of the disclosure.

Referring to FIG. 6, the types of food materials to be added in the refrigerator may be recognized based on the first image obtained through the first camera (S601).

Further, the ethylene information associated with the food materials may be obtained based on the types of the food materials (S602). Here, the ethylene information may include the degree of incidence of ethylene in the food materials and the degree of sensitivity of the food materials to ethylene.

Then, information associated with the other food materials stored in the plurality of storage compartments may be obtained (S603).

Further, based on the ethylene information associated with the food materials and the information associated with the other food materials, information about the storage compartment in which the food materials are to be stored from among the plurality of storage compartments may be identified (S604).

Then, the information about the identified storage compartment may be provided (S605).

In step S603, the storage compartment in which the other food materials are stored may be determined based on the second image obtained through the second camera disposed to face the storage compartments.

The, based on the second image, the types of the other food materials may be recognized.

Next, based on the types of the recognized other food materials, the ethylene information associated with the other food materials may be obtained.

Further, based on the storage compartment in which the other food materials are stored and the ethylene information associated with the other food materials, information associated with the other food materials may be obtained.

Here, ethylene information associated with the other food materials may include the degree of incidence of ethylene in the other food materials and the degree of sensitivity of the other food materials to ethylene.

In step S604, based on the ethylene information associated with the food materials, the storage compartment in which the other food materials are stored, and the ethylene information associated with the other food materials, information about the storage compartment in which the food materials are to be stored may be identified.

Further, in step S604, based on the degree of sensitivity of the food materials to ethylene and the degree of incidence of ethylene in the other food materials, information about the storage compartment in which the food materials are to be stored may be identified.

In addition, in step S604, based on the degree of sensitivity of the food materials to ethylene and the degree of incidence of ethylene in the other food materials, information about the storage compartment in which the food materials are to be stored may be identified.

Meanwhile, in step S604, information about the storage compartment in which the food materials are to be stored may be identified based on the temperatures of the plurality of storage compartments and the setting temperature of the refrigerator.

Further, in step S605, the information about the identified storage compartment may be provided through the display.

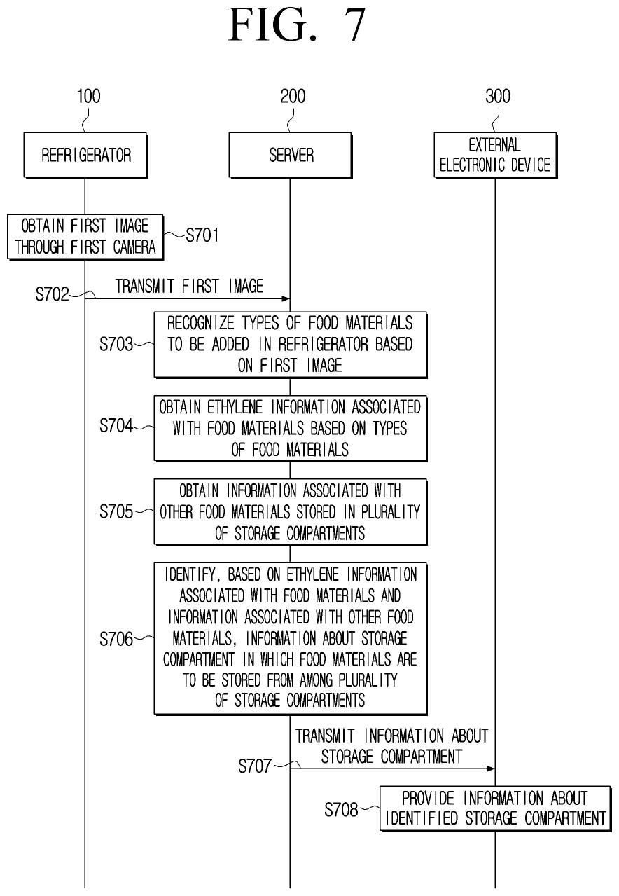

FIG. 7 is a sequence diagram illustrating a control method of a refrigerator according to an embodiment of the disclosure.

Referring to FIG. 7, the refrigerator 100 may obtain the first image through the first camera (S701).

Further, the refrigerator 100 may transmit the first image to a server 200 (S702).

Then, the server 200 may recognize the types of food materials to be added to the refrigerator based on the first image (S703).

Then, the server 200 may obtain the ethylene information associated with the food materials based on the types of the food materials (S704).

Then, the server 200 may obtain information associated with the other food materials stored in the plurality of storage compartments (S705).

Then, the server 200 may identify, based on the ethylene information associated with the food materials and the information associated with the other food materials, the information about the storage compartment in which the food materials are to be stored from among the plurality of storage compartments (S706).

Then, the server 200 may transmit the information about the storage compartment to an external electronic device 300.

Here, the server 200 may transmit the information about the storage compartment to the refrigerator 100.

Then, the external electronic device 300 may provide the information about the identified storage compartment (S708).

Functions associated with artificial intelligence according to the disclosure may be operated through a processor and a memory of an electronic device.

The processor may be configured with one or a plurality of processors. At this time, the one or plurality of processors may include at least one from among a central processing unit (CPU), a graphic processing unit (GPU), and a neural processing unit (NPU), but is not limited to the example of the above-described processor.

The CPU may be a generic-purpose processor which can perform not only general operations, but also artificial intelligence operations, and may efficiently execute complex programs through a multi-tiered cache structure. The CPU may be advantageous in a series processing method which allows for an organic connection between a previous calculation result and a following calculation result to be possible through a sequential calculation. The generic-purpose processor may not be limited to the above-described example except for when specified as the above-described CPU.

The GPU may be a processor for mass operations such as a floating point operation used in graphics processing, and perform a large-scale operation by integrating cores in mass in parallel. Specifically, the GPU may be advantageous in a parallel processing method such as a convolution operation compared to the CPU. In addition, the GPU may be used as a co-processor for supplementing a function of the CPU. The processor for mass operations may not be limited to the above-described example except for when specified as the above-described GPU.

The NPU may be a processor which specializes in an artificial intelligence operation using an artificial neural network, and may implement each layer that forms the artificial neural network with hardware (e.g., silicon). At this time, because the NPU is designed specialized according to a required specification of a company, there is a lower degree of freedom compared to the CPU or the GPU, but the NPU may efficiently process the artificial intelligence operation demanded by the company. Meanwhile, as a processor specializing in the artificial intelligence operation, the NPU may be implemented in various forms such as, for example, and without limitation, a tensor processing unit (TPU), an intelligence processing unit (IPU), a vision processing unit (VPU), and the like. The artificial intelligence processor may not be limited to the above-described example except for when specified as the above-described NPU.

In addition, the one or plurality of processors may be implemented as a System on Chip (SoC). At this time, the SoC may be further included with the memory in addition to the one or plurality of processors, and a network interface such as a Bus for data communication between the processor and the memory.

If a plurality of processors are included in the System on Chip (SoC) included in the electronic device, the electronic device may perform an operation associated with artificial intelligence (e.g., an operation associated with training or inference of an artificial intelligence model) using a portion of the processors from among the plurality of processors. For example, the electronic device may perform an operation associated with artificial intelligence using at least one from among the GPU, the NPU, the VPU, the TPU, and a hardware accelerator specializing in artificial intelligence operations such as the convolution operation, and a matrix multiplication operation from among the plurality of processors. However, the above is merely one embodiment, and operations associated with artificial intelligence may be processed using the generic-purpose processor such as the CPU.

In addition, the electronic device may perform an operation for a function associated with artificial intelligence by using multicores (e.g., a dual core, a quad core, etc.) included in one processor. Specifically, the electronic device may perform artificial intelligence operations such as the convolution operation, and the matrix multiplication operation in parallel using the multicores included in the processor.

The one or plurality of processors may control to process input data according to a pre-defined operation rule or an artificial intelligence model stored in the memory. The pre-defined operation rule or the artificial intelligence model is characterized by being created through training.

Here, the being created through training may mean a pre-defined operation rule or an artificial intelligence model of a desired characteristic being created by applying a learning algorithm to a plurality of training data. The training may be carried out in a device itself in which the artificial intelligence according to the disclosure is performed, or carried out through a separate server/system.

The artificial intelligence model may be formed of a plurality of neural network layers. At least one layer may have at least one weight value, and perform a layer operation through an operation result of a previous layer and at least one defined operation. Examples of the neural network may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep-Q Networks, and a Transformer, and the neural network in the disclosure may not be limited to the above-described examples except for when specified.

The learning algorithm may be a method for training a predetermined target machine (e.g., robot) to make decisions or predictions on its own using the plurality of training data. Examples of the learning algorithm may include a supervised learning, an unsupervised learning, a semi-supervised learning, or a reinforcement learning, and the learning algorithm of the disclosure is not limited to the above-described examples unless otherwise specified.

Meanwhile, according to an embodiment of the disclosure, the various embodiments described above may be implemented with software including instructions stored in a machine-readable storage media (e.g., computer). The machine may call a stored instruction from a storage medium, and as a device operable according to the called instruction, may include a device according to the above-mentioned embodiments. Based on the instruction being executed by the processor, the processor may directly or using other elements under the control of the processor perform a function corresponding to the instruction. The instruction may include a code generated by a compiler or executed by an interpreter. A machine-readable storage medium may be provided in a form of a non-transitory storage medium. Herein, ‘non-transitory’ merely means that it is a tangible device, that it does not include a signal (e.g., electromagnetic waves), and the term does not differentiate data being semi-permanently stored or being temporarily stored in the storage medium. For example, the ‘non-transitory storage medium’ may include a buffer in which data is temporarily stored.

According to an embodiment, a method according to the various embodiments disclosed in the disclosure may be provided included a computer program product. The computer program product may be exchanged between a seller and a purchaser as a commodity. The computer program product may be distributed in the form of the machine-readable storage medium (e.g., a compact disc read only memory (CD-ROM)), or distributed online (e.g., downloaded or uploaded) through an application store (e.g., PLAYSTORE™) or directly between two user devices (e.g., smartphones). In the case of online distribution, at least a portion of the computer program product (e.g., downloadable app) may be stored at least temporarily in the machine-readable storage medium such as a server of a manufacturer, a server of an application store, or a memory of a relay server, or temporarily generated.

While the disclosure has been illustrated and described with reference to example embodiments thereof, it will be understood that the example embodiments are intended to be illustrative, not limiting. It will be understood by those skilled in the art that various changes in form and details may be made therein without departing from the true spirit and full scope of the disclosure, including the appended claims and their equivalents.

1. A refrigerator, comprising:
a plurality of storage compartments;
a camera;
a memory; and
at least one processor configured to:
recognize a type of food material to be added in the refrigerator based on an image obtained through the camera,
obtain ethylene information associated with the food material based on the type of the food material,
obtain information associated with at least one other food material stored in one of the plurality of storage compartments,
identify, based on the ethylene information associated with the food material and the information associated with the at least one other food material, a storage compartment in which the food material is to be stored either separately or collectively with the at least one other food material from among the plurality of storage compartments, and
provide information about the identified storage compartment in which the food material is to be stored.

2. The refrigerator of claim 1, wherein the camera is disposed at a front surface of the refrigerator, and
the ethylene information comprises a degree of incidence of ethylene in the food material and a degree of sensitivity of the food material to ethylene.

3. The refrigerator of claim 1, wherein the camera is a first camera, the image is a first image and the refrigerator further comprises:
a second camera to be disposed to face the plurality of storage compartments,
wherein the at least one processor is configured to:
determine, based on a second image obtained through the second camera, a storage compartment in which the at least one other food material is stored,
recognize, based on the second image, a type of the at least one other food material,
obtain, based on the recognized type of the at least one other food material, ethylene information associated therewith, and
obtain, based on the storage compartment in which the at least one other food material is stored and the ethylene information associated therewith, information associated with the at least one other food material.

4. The refrigerator of claim 3, wherein
the ethylene information associated with the at least one other food material comprises a degree of incidence of ethylene in the at least one other food material and a degree of sensitivity of the at least one other food material to ethylene.

5. The refrigerator of claim 3, wherein
the at least one processor is configured to
identify, based on the ethylene information associated with the food material, the storage compartment in which the at least one other food material is stored, and the ethylene information associated with the at least one other food material, information about a storage compartment in which the at least one other food material is to be stored.

6. The refrigerator of claim 3, wherein
the at least one processor is configured to
identify, based on a degree of sensitivity of the food material to ethylene and a degree of incidence of ethylene in the at least one other food material, information about a storage compartment in which the food material is to be stored.

7. The refrigerator of claim 3, wherein
the at least one processor is configured to:
identify, based on a degree of incidence of ethylene in the food material and a degree of sensitivity of the at least one other food material to ethylene, information about a storage compartment in which the food material is to be stored.

8. The refrigerator of claim 1, wherein
the at least one processor is configured to:
identify information about a storage compartment in which the food material is to be stored based on temperatures of the plurality of storage compartments and a setting temperature of the refrigerator.

9. The refrigerator of claim 1, further comprising:
a display,
wherein the at least one processor is configured to provide information about the identified storage compartment through the display.

10. A method for controlling a refrigerator comprising a plurality of storage compartments, and a camera, the method comprising:
recognizing a type of food material to be added in the refrigerator based on an image obtained through the camera;
obtaining ethylene information associated with the food material based on the type of the food material;
obtaining information associated with at least one other food material stored in the plurality of storage compartments;
identifying, based on the ethylene information associated with the food material and the information associated with the at least one other food material, a storage compartment in which the food material is to be stored either separately or collectively with the at least one other food material from among the plurality of storage compartments; and
providing information about the identified storage compartment in which the food material is to be stored.

11. The method of claim 10, wherein the camera is at a front surface of the refrigerator, and
the ethylene information comprises a degree of incidence of ethylene in the food material and a degree of sensitivity of the food material to ethylene.

12. The method of claim 10, wherein the camera is a first camera, the image is a first image and the refrigerator
the obtaining information associated with at least one other food material comprises:
determining, based on a second image obtained through a second camera disposed to face the plurality of storage compartments, a storage compartment in which the at least one other food material is stored;
recognizing, based on the second image, a type of the at least one other food material,
obtaining, based on the recognized type of the at least one other food material, ethylene information associated with the at least one other food material; and
obtaining, based on the storage compartment in which the at least one other food material is stored and the ethylene information associated with the at least one other food material, information associated with the at least one other food material.

13. The method of claim 12, wherein
the ethylene information associated with the at least one other food material comprises a degree of incidence of ethylene in the at least one other food material and a degree of sensitivity of the at least one other food material to ethylene.

14. The method of claim 12, wherein
the obtaining information associated with at least one other food material comprises
identifying, based on the ethylene information associated with the food material, the storage compartment in which the at least one other food material is stored, and the ethylene information associated with the at least one other food material, information about a storage compartment in which the food material is to be stored.

15. The method of claim 12, wherein
the obtaining information associated with at least one other food material comprises
identifying, based on a degree of sensitivity of the food material to ethylene and a degree of incidence of ethylene in the at least one other food material, information about a storage compartment in which the food material is to be stored.

16. The method of claim 12, wherein
the obtaining information associated with at least one other food material comprises
identifying, based on a degree of incidence of ethylene in the food material and a degree of sensitivity of the at least one other food material to ethylene, information about a storage compartment in which the food material is to be stored.

17. The method of claim 10, wherein
the obtaining information associated with at least one other food material comprises
identifying information about a storage compartment in which the food material is to be stored based on temperatures of the plurality of storage compartments and a setting temperature of the refrigerator.

18. The method of claim 10, further comprising:
providing information about the identified storage compartment through a display of the refrigerator.

19. A non-transitory computer-readable medium that stores computer instructions executable by a processor of a refrigerator to execute an operation, the refrigerator including a plurality of storage compartments, and a camera, the operation comprising:
recognizing a type of food material to be added in the refrigerator based on an image captured by the camera;
obtaining ethylene information associated with the food material based on a type of food material;
obtaining information associated with at least one other food material stored in the plurality of storage compartments;
identifying, based on the ethylene information associated with the food material and the information associated with the at least one other food material, a storage compartment in which the food material is to be stored either separately or collectively with the at least one other food material from among the plurality of storage compartments; and
providing information about the identified storage compartment in which the food material is to be stored.

20. The medium of claim 19, wherein the camera is at a front surface of the refrigerator, and
the ethylene information comprises a degree of incidence of ethylene in the food material and a degree of sensitivity of the food material to ethylene.
